(19) United States
(12) Patent Application Publication
(10) Pub. No.: US 2021/0009796 A1
(43) Pub. Date: Jan. 14, 2021

(54) RESIN SHEET, LAMINATE, FORMED BODY AND METHOD FOR PRODUCING FORMED BODY

(71) Applicant: IDEMITSU UNITECH CO., LTD., Tokyo (JP)

(72) Inventors: Satomi ASAOMO, Chiba (JP); Kaname KONDO, Chiba (JP)

(73) Assignee: IDEMITSU UNITECH CO., LTD., Tokyo (JP)

(21) Appl. No.: 16/968,274

(22) PCT Filed: Jan. 21, 2019
(86) PCT No.: PCT/JP2019/001620

§ 371 Date: Aug. 7, 2020

(30) Foreign Application Priority Data
Feb. 8, 2018 (JP) 2018-021035

(51) Int. Cl. C08L 23/12; C08K 5/20; B32B 15/08; B32B 27/32; B32B 9/00; B32B 9/04; B32B 37/10; B29C 45/14

(52) U.S. Cl. CPC C08L 23/12; C08K 5/20; B32B 15/08; B32B 27/32; B29K 2623/12; B32B 9/045; B32B 37/10; B29C 45/14811; B32B 9/005

(57) ABSTRACT

A resin sheet comprising polypropylene and one or more selected from the group consisting of a β crystal nucleating agent and a petroleum resin, wherein the resin sheet has a crystallization speed at 130° C. of 2.5 min⁻¹ or less and an isotactic pentad fraction of 95 mol % or more and 99 mol % or less.

### TECHNICAL FIELD

The present invention relates to a resin sheet, a laminate, a formed body, and a method of producing the formed body.

### BACKGROUND ART

Conventionally, painting or plating has been the main method for applying a design to a formed article. However, since painting emits a large amount of volatile organic compound (VOCs) and plating generates a large amount of waste liquid and toxic substances, both methods are environmentally burdensome.

In recent years, a method of applying a design for the purpose of reducing an environmental load has been actively studied, and a new method of applying a design (decorative forming method) has been developed in which one or both of printing and surface shapes are applied to a sheet and the sheet is integrated with a formed article.

Patent Document 1 discloses a decorative sheet containing at least one selected from aliphatic petroleum resin, alicyclic petroleum resin, and polyterpene petroleum resin. This sheet has a crystalline heat of fusion of 80 to 150 J/g and a tensile modulus of 8,000 to 20,000 kg/cm², and is excellent in scratch resistance. However, this sheet is not suitable for decorative forming because it is laminated to a base material such as plywood or steel plate using an adhesive or an adhesive.

In Patent Document 2, a laminate structure is disclosed which is composed of a film or sheet containing a propylene-based resin and petroleum resin, and a base material made of an olefin-based resin composition. Although the film or sheet in Patent Document 2 is subjected to a heat aging treatment, the surface hardness was insufficient.

### RELATED ART DOCUMENTS

### Patent Literature

Patent Literature 1: JP-A-2000-336181

Patent Literature 2: JP-A-2000-38459

### SUMMARY OF INVENTION

As a sheet used for the decorative forming method, a polypropylene sheet made of polypropylene is expected. The polypropylene sheet is excellent in formability and chemical resistance, and can be reduced in weight, but has a problem of poor scratch resistance because of insufficient surface hardness.

An object of the present invention is to provide a resin sheet having excellent surface hardness.

As a result of intensive study, the present inventors have found that a resin sheet containing polypropylene and one or more selected from the group consisting of a petroleum resin and a β crystal nucleating agent exhibits excellent surface hardness, and thus the present invention has been completed.

According to the present invention, the following resin sheet and the like are provided.
1. A resin sheet comprising polypropylene and one or more selected from the group consisting of a β crystal nucleating agent and a petroleum resin,

wherein the resin sheet has a crystallization speed at 130° C. of 2.5 min⁻¹ or less and an isotactic pentad fraction of 95 mol % or more and 99 mol % or less.
2. The resin sheet according to 1, wherein the polypropylene is a propylene homopolymer.
3. The resin sheet according to 1 or 2, wherein the polypropylene comprises a smectic phase crystal.
4. The resin sheet according to any one of 1 to 3, wherein the polypropylene has an exothermic peak of 1.0 J/g or more on a low temperature side of a maximum endothermic peak on a differential scanning calorimetry curve.
5. The resin sheet according to any one of 1 to 4, wherein the β crystal nucleating agent is an amide compound.
6. The resin sheet according to any one of 1 to 5, wherein the β crystal nucleating agent is comprised in an amount of 10,000 mass ppm or more and 100,000 mass ppm or less.
7. The resin sheet according to any one of 1 to 6, wherein the petroleum resin is a hydrogenated aromatic petroleum resin.
8. The resin sheet according to any one of 1 to 7, wherein the petroleum resin is comprised in an amount of 10 mass % or more and 30 mass % or less.
9. The resin sheet according to any one of 1 to 8, which further comprises a dispersant.
10. The resin sheet according to 9, wherein the dispersant is one or more selected from the group consisting of alkyldiethanolamine, polyoxyethylenealkylamide, monoglycerin fatty acid ester, and diglycerin fatty acid ester.
11. The resin sheet according to 9 or 10, wherein the dispersant is comprised in an amount of 10 mass ppm or more and 10,000 mass ppm or less.
12. A laminate comprising the resin sheet according to any one of 1 to 11 as a first layer.
13. The laminate according to 12 which comprises a second layer comprising polypropylene and a petroleum resin.
14. The laminate according to 13, wherein the laminate has a crystallization speed at 130° C. of 2.5 min⁻¹ or less and an isotactic pentad fraction of 95 mol % or more and 99 mol % or less. 15. The laminate according to 13 or 14, wherein the polypropylene in the second layer is a propylene homopolymer.
16. The laminate according to any one of 13 to 15, wherein the polypropylene in the second layer comprises a smectic phase crystal.
17. The laminate according to any one of 13 to 16, wherein the polypropylene of the second layer has an exothermic peak of 1.0 J/g or more on a low temperature side of a maximum endothermic peak on a differential scanning calorimetry curve.
18. The laminate according to any one of 13 to 17, wherein the petroleum resin in the second layer is a hydrogenated aromatic petroleum resin.
19. The laminate according to any one of 13 to 18, wherein the second layer comprises the petroleum resin in an amount of 10 mass % or more and 30 mass % or less.
20. The laminate according to any one of 13 to 19, which further comprises a third layer comprising one or more selected from the group consisting of an urethane resin, an acrylic resin, a polyolefin resin, and a polyester resin,

wherein the laminate comprises the second layer, the first layer and the third layer in this order, or the laminate comprises the third layer, the second layer and the first layer in this order.
21. The laminate according to any one of 13 to 19, which further comprises a third layer comprising one or more selected from the group consisting of an urethane resin, an acrylic resin, a polyolefin resin, and a polyester resin, and a fourth layer comprising a resin which is one or more selected from the group consisting of an urethane resin, an acrylic resin, a polyolefin resin and a polyester resin, and is different from the resin comprised in the third layer,

wherein the laminate comprises the second layer, the first layer, the third layer, and the fourth layer in this order, or the laminate comprises the fourth layer, the third layer, the second layer, and the first layer in this order.
22. The laminate according to 20, wherein the laminate comprises a metal layer comprising a metal or an oxide of the metal on a surface of the third layer which is an opposite side to the first layer.
23. The laminate according to 21, wherein the laminate comprises a metal layer comprising a metal or an oxide of the metal on a surface of the fourth layer which is an opposite side to the third layer.
24. The laminate according to 22 or 23, wherein the metal element comprised in the metal layer is one or more selected from the group consisting of tin, indium, chromium, aluminum, nickel, copper, silver, gold, platinum, and zinc.
25. The laminate according to any one of 22 to 24, wherein the metal element comprised in the metal layer is one or more selected from the group consisting of indium, aluminum, and chromium.
26. The laminate according to any one of 22 to 25, which comprises a print layer on a part or entire surface of the metal layer opposite to the third layer.
27. A formed body of the laminate according to any one of 12 to 15 and 17 to 26 which are not dependent on 3.
28. A method for producing a formed body by forming the laminate according to any one of 12 to 26 to obtain a formed body.
29. The method for producing a formed body according to 28, wherein the forming is performed by placing the laminate on a mold and supplying a resin for molding to integrate the laminate and the resin for molding.
30. The method for producing a formed body according to 28, wherein the forming is performed by shaping the laminate so as to conform to a mold, placing the shaped laminate to the mold, and supplying a resin for molding to integrate the shaped laminate and the resin for molding.
31. The method for producing a formed body according to 28, wherein the forming is performed by arranging a core material in a chamber box, arranging the laminate above the core material, depressurizing the inside of the chamber box, heating and softening the laminate, and pressing the heated and softened laminate against the core material to cover the core material.

According to the present invention, a resin sheet having excellent surface hardness can be provided.

### BRIEF DESCRIPTION OF THE DRAWINGS

FIG. 1 is a schematic cross-sectional view showing an embodiment of a laminate according to one aspect of the invention;

FIG. 2 is a schematic diagram of an apparatus used for manufacturing a resin sheet in Example 1.

### MODE FOR CARRYING OUT THE INVENTION

### [Resin Sheet]

The resin sheet according to one aspect of the invention contains polypropylene and one or more selected from the group consisting of a petroleum resin and a β crystal nucleating agent, and has a crystallization speed at 130° C. of 2.5 min⁻¹ or less, and an isotactic pentad fraction of 95 mol % or more and 99 mol % or less.

In the resin sheet according to the present embodiment, it is inferred that, by adding a petroleum resin to polypropylene, the petroleum resin is incorporated into the amorphous phase of the polypropylene, and the hardness of the resin sheet is improved. In addition, it is inferred that the β crystal nucleating agent functions as a reinforcing agent by adding the β crystal nucleating agent to the polypropylene, and the hardness of the resin sheet is improved.

The isotactic pentad fraction of the resin sheet is 95 mol % or more and 99 mol % or less, preferably 96 mol % or more and 99 mol % or less, more preferably 97 mol % or more and 99 mol % or less.

When the isotactic pentad fraction of the resin sheet is less than 95 mol %, the rigidity of the resin sheet may be insufficient. On the other hand, when the isotactic pentad fraction exceeds 99 mol %, the transparency may be lowered.

The isotactic pentad fraction of the resin sheet can mean the isotactic pentad fraction of polypropylene contained in the resin sheet, and is the isotactic fraction of pentad units (consecutive isotactically bounded five propylene monomers) in the molecular chain of the polypropylene resin composition. The isotactic pentad fraction of the resin sheet can be measured by the method described in the examples.

Preferably, the resin sheet has a crystallization speed at 130° C. of 2.5 min⁻¹ or less, and more preferably, the resin sheet has a crystallization speed at 130° C. of 2.0 min⁻¹ or less. Here, the crystallization speed of the resin sheet can mean the crystallization speed of polypropylene contained in the resin sheet.

When the crystallization speed of the resin sheet at 130° C. is 2.5 min⁻¹ or less, the resin sheet can be prevented from rapidly curing the portion contacting a mold, and the like, thereby preventing the deterioration of the design of the resin sheet. The lower limit of the crystallization speed of the resin sheet at 130° C. is not particularly limited, but is, for example, 0.001 min⁻¹.

The crystallization speed of the resin sheet at 130° C. can be measured by the method described in the examples.

Hereinafter, each component contained in the resin sheet will be described.

Polypropylene is a polymer containing at least propylene. Specific examples include homo-polypropylene (propylene homopolymer), a copolymer of propylene and an olefin, and the like. Among these, homo-polypropylene is preferable from the viewpoints of heat resistance and hardness.

The copolymer of propylene and an olefin may be a block copolymer, a random copolymer, or a mixture thereof. Olefin includes ethylene, butylene, cycloolefin, and the like.

The melt flow rate of polypropylene (hereinafter sometimes referred to as “MFR”) is preferably in the range of 0.5 to 10 g/10min. Within this range, excellent formability into a film shape or a sheet shape can be obtained. MFR of polypropylene can be measured according to JIS-K7210:2014 at a measured temperature of 230° C. and a load of 2.16 kg.

The polypropylenes preferably have an exothermic peak of 1.0 J/g or more (more preferably 1.5 J/g or more) on a low temperature side of a maximum endothermic peak on a differential scanning calorimetry curve. The upper limit is not particularly limited, but is usually 10 J/g or less.

The exothermic peak is measured using a differential scanning calorimeter.

The polypropylene preferably contains a smectic phase crystal as a crystal structure. The smectic phase crystal is an intermediate phase in a metastable state, and is excellent in transparency because each domain size is small. In addition, the smectic phase crystal is in the metastable state, accordingly the sheet is softened at a low calorific value as compared with that containing the crystallized α crystal, and accordingly has a feature of being excellent in the formability.

As the crystal structure of polypropylene, other crystal forms such as β crystal, γ crystal, amorphous part and the like may be contained in addition to smectic phase crystal.

30 mass % or more, 50 mass % or more, 70 mass % or more, 85 mass % or more, or 90 mass % or more of polypropylene in the resin sheet may be smectic phase crystal. The presence or absence of a smectic phase crystal in a resin sheet can be confirmed by the method described in the examples.

In order to obtain a resin sheet having an isotactic pentad fraction of 95 mol % or more and 99 mol % or less and a crystallization speed of 2.5 min⁻¹ or less and excellent in transparency and luster, a smectic phase crystal may be formed in the polypropylene of the resin sheet.

In the production of a formed body described later, polypropylene is transformed into α crystal while maintaining the microstructure derived from the smectic phase crystal by the shaping after the heating. If the resin sheet after forming has an isotactic pentad fraction of 95 mol % or more and 99 mol % or less and a crystallization speed of 2.5 min⁻¹ or less, then the resin sheet can be said to be derived from the smectic phase crystal.

The content ratio of polypropylene in the resin sheet is, for example, 50 mass % or more and 99 mass % or less, and preferably 85 mass % or more and 99 mass % or less.

The β crystal nucleating agent is a nucleating agent capable of selectively generating β crystals among the crystal structures of polypropylene. The β crystal is one of the crystal structures of polypropylene, and has a harder crystal structure than the α crystal which is most easily produced.

As the β crystal nucleating agent, an amide compound; a tetraoxaspiro compound; quinacridones; a nanosized iron oxide; alkaline or alkaline earth metal salts of carboxylic acids such as potassium 1,2-hydroxystearate, magnesium benzoate, magnesium succinate and magnesium phthalate; aromatic sulfonic acid compound such as sodium benzenesulfonate and sodium naphthalenesulfonate; di- or tri-esters of di- or tri-base carboxylic acids; phthalocyanine-based pigments such as phthalocyanine blue; two-component system compound containing component a which is an organic dibasic acid and component b which is an oxide, a hydroxide or a salt of an alkaline earth metal; a composition containing a cyclic phosphorus compound and a magnesium compound and the like can be given. Among these, an amide compound is preferable.

In addition, a substance specifically described in JP2003-306585, JP-H8-144122, or JP-H9-194650 can be used.

The above β crystal nucleating agent may be used in single or in combination with two or more.

Commercial products of the β crystal nucleating agent includes “N jester NU-100” (New Nippon Chemical Co., Ltd.) and the like. “N jester NU-100” is structured in such a way that naphthalene has cyclohexane via an amide-bond.

The content of the β crystal nucleating agent in the resin sheet is, for example, 3,000 mass ppm or more and 100,000 mass ppm or less, and preferably 10,000 mass ppm or more and 100,000 mass ppm or less. If the content of the β crystal nucleating agent is less than 3,000 mass ppm, improvement in hardness may not be expected. On the other hand, if the content of the β crystal nucleating agent exceeds 100,000 mass ppm, the transparency may be remarkably deteriorated.

When the resin sheet contains a β crystal nucleating agent, it is preferable to further contain a dispersing agent.

When the β crystal nucleating agent is an amide compound having an amide bond, the β crystal nucleating agent generally has poor dispersibility because hydrogen bonds are formed between the β crystal nucleating agents. Then, the dispersibility of the β crystal nucleating agent can be improved by adding a dispersing agent which selectively binds to the amide bond of the β crystal nucleating agent and inhibits the hydrogen bond of the β crystal nucleating agent.

As the dispersant, a known low molecular type dispersant or a known high molecular type dispersant which is generally used as an antistatic agent can be suitably used.

Examples of the low molecular weight dispersant include non-ionic dispersants such as alkyldiethanolamine, polyoxyethylenealkylamide, monoglycerin fatty acid ester, diglycerin fatty acid ester, sorbitan fatty acid ester; cationic dispersant of tetraalkylammonium salt type; anionic dispersant such as alkyl sulfonate salt; and amphoteric dispersant such as alkyl betaine.

Examples of the polymeric dispersant include a nonionic dispersant such as polyetheresteramide; an anionic dispersant such as polystyrene sulfonic acid; and a cationic dispersant such as a polymer containing quaternary ammonium salt.

Among the above, the dispersant is preferably one or more selected from the group consisting of alkyldiethanolamine, polyoxyethylenealkylamide, monoglycerin fatty acid ester, and diglycerin fatty acid ester.

The dispersant may be used in single or in combination with two or more.

Commercial products of the dispersant include “ISU-200” (manufactured by Takemoto Oil & Fat Co., Ltd.), “Rikemaster PSR-300” (manufactured by Riken Vitamin Co., Ltd.), “Anstex SA-20” (manufactured by Toho Chemical Co., Ltd.), “PPM AST-42AL” (manufactured by Tokyo Ink Co., Ltd.), “OGSOL MF-11” (manufactured by Osaka Gas Chemical Co., Ltd.), and the like.

The content of the dispersant in the resin sheet is preferably 10 mass ppm or more and 10,000 mass ppm or less, more preferably 1,000 mass ppm or more and 10,000 mass ppm or less. If the content of the dispersant is less than 10 mass ppm, the β crystal nucleating agent may not be sufficiently dispersed. On the other hand, if the content of the dispersant exceeds 10,000 mass ppm, the dispersant may bleed out and impair the appearance.

Petroleum resin means, for example, a resin solidified by an acidic catalyst without isolating unsaturated hydrocarbons mainly from C5 and C9 fractions among the remaining fractions obtained by pyrolyzing petroleum naphtha to collect necessary fractions.

The softening point of the petroleum resin is preferably 80° C. or more and 170° C. or less, more preferably 110° C. or more and 170° C. or less. If the softening point of the petroleum resin is less than 80° C., the heat resistance of the resin sheet may be lowered, and the petroleum resin component may easily bleed out to the surface under a high-temperature atmosphere. On the other hand, when the softening point of the petroleum resin exceeds 170° C., it exceeds the melting point of polypropylene, so that the resin sheet may not soften in the molding temperature region where the formed body does not whiten.

The softening point of petroleum resins can be measured by methods according to JIS K2207:2006.

The number average molecular weight of the petroleum resin is preferably 720 or more and 1085 or less.

When the number average molecular weight of the petroleum resin is less than 720, the heat resistance of the resin sheet may be lowered, and the petroleum resin component may easily bleed out to the surface under a high-temperature atmosphere. On the other hand, when the number average molecular weight of the petroleum resin exceeds 1085, there is a possibility that the resin sheet cannot be softened in a molding temperature region in which the formed body does not become white.

The number average molecular weight of the petroleum resin can be confirmed by gel permeation chromatography.

Examples of the petroleum resin include an aromatic petroleum resin, an aliphatic petroleum resin, aromatic hydrocarbon resins, alicyclic saturated hydrocarbon resins, copolymer petroleum resins, and hydrogenated derivatives of these petroleum resins. Among these, from the viewpoint of transparency and formability, a hydrogen aromatic petroleum resin, and a copolymer containing an aromatic petroleum resin is preferable, and a hydrogenated aromatic petroleum resin, and a copolymer of an aromatic petroleum resin and dicyclopentadiene is more preferable.

Specific examples of the petroleum resin include a rosin-based resin, a terpene-based resin, a coumarone-indene resin, an alkylphenol resin and hydrogenated derivatives thereof.

The rosin-based resin is a resin mainly composed of abietic acid or a derivative thereof obtained from a pine resin and the like, and includes, for example, gum rosin, wood rosin, hydrogenated rosin, ester rosin esterified with alcohol, rosin phenol resin obtained by reacting phenol and rosin, and the like.

The terpene-based resin is a resin of which material is a telepin oil, and includes, for example, a terpene resin in which α-pinene or β-pinene is polymerized, a terpene phenol resin in which phenol and terpene are reacted, an aromatic modified terpene resin in which polarities are imparted by styrene or the like, a hydrogenated terpene resin, and the like.

The coumarone-indene resin is a resin composed of a polymer mainly composed of coumarone and indene.

The alkylphenol resin is a resin obtained by reacting an alkylphenol with an aldehyde.

Petroleum resin may be used in single or in combination with two or more kinds.

Examples of commercial products of the petroleum resin include “I-MARV” (manufactured by Idemitsu Kosan Co., Ltd.), “ARKON” (manufactured by Arakawa Chemical Industries,Ltd.), “ Oppera” and “Escorez” (manufactured by Exxon Mobil Corporation.), “Hi-rez” and “PETROSIN” (manufactured by Mitsui Chemicals, Inc.), “SUKOREZ” (manufactured by Kolon Industries, Inc.), “Regalite”, “Eastotac” and “Plastolyn” (manufactured by Eastman Chemical Company), “CLEARON” (manufactured by YASUHARA CHEMICAL CO., LTD.), and the like.

When the resin sheet contains a petroleum resin, the content of the petroleum resin in the resin sheet is preferably 3 mass % or more and 30 mass % or less, more preferably 5 mass % or more and 30 mass % or less, and still more preferably 10 mass % or more and 30 mass % or less. When the content of the petroleum resin is less than 3 mass %, the hardness may not be improved. On the other hand, when the content of the petroleum resin is more than 30 mass %, the petroleum resin may bleed out, thereby impairing the appearance.

The resin sheet according to the embodiment may contain, as an optional component, one or more selected from the group consisting of a pigment, an antioxidant, a stabilizer, and an ultraviolet absorber. As another optional component, a modified polyolefin resin obtained by modifying an olefin with a modifying compound such as maleic anhydride, dimethyl maleate, diethyl maleate, acrylic acid, methacrylic acid, tetrahydrophthalic acid, glycidyl methacrylate, hydroxyethyl methacrylate, methyl methacrylate, or the like may be included.

The resin sheet according to the embodiment may consist essentially of one or more selected from the group consisting of a β crystal nucleating agent and a petroleum resin; polypropylene; and an optional component. For example, 80 mass % or more, 90 mass % or more, or 95 mass % or more of the resin sheet according to the embodiment may be one or more selected from the group consisting of a β crystal nucleating agent and a petroleum resin; polypropylene; and an optional component.

The resin sheet according to the embodiment may consists of one or more selected from the group consisting of a β crystal nucleating agent and a petroleum resin; polypropylene; and an optional component. In this case, an inevitable impuritie may be contained.

As a method of forming the resin sheet according to the present embodiment, an extrusion method or the like can be given.

The extrusion method includes cooling of the melted resin, and the cooling is preferably performed at 80° C./sec or more until the internal temperature of the resin sheet becomes equal to or lower than the crystallization temperature. As a result, the crystal structure of polypropylene included in the resin sheet can be made into a smectic phase crystal. The cooling is more preferably 90° C./sec. or more, and more preferably 150° C./sec. or more.

By calculating the scattering intensity distribution and the long period by the small angle X-ray scattering analysis method, it is possible to judge whether the resin sheet is obtained by cooling at 80° C./sec or more or not. That is, it is possible to determine by the above analysis whether or not a resin sheet has a microstructure derived from smectic phase crystal.

Here, the long period of the resin sheet indicates the inter-lamellar distance of the crystalline polypropylene included in the resin sheet. The finer the crystal structure of polypropylene, the shorter the inter-lamellar distance and the smaller the value of the long period. Therefore, by measuring the long period, it can be determined whether the resin sheet has a microstructure derived from a smectic phase crystal.

As the raw material polypropylene used for forming the resin sheet, it is preferable to use polypropylene having an isotactic pentad fraction of 95 mol % or more and 99 mol % or less and a crystallization speed of 2.5 min⁻¹ or less.

The measurement of the isotactic pentad fraction and the crystallization speed of the raw polypropylene can be performed in the same manner as the measurement of the isotactic pentad fraction and the crystallization speed of the resin sheet, and the measurement sample need only be changed from the resin sheet to the raw polypropylene.

The resin sheet may be a single resin sheet, or the resin sheet may be a stacked structure of two or more layers. When the resin sheet is a laminate of two or more layers, the components included in the two or more layers may be the same or different from each other. For example, when the resin sheet is a two-layer stacked structure, a laminate of a first resin sheet containing polypropylene, a β crystal nucleating agent, a dispersant, and a petroleum resin, and a second resin sheet containing polypropylene and a petroleum resin can be used.

The thickness of the resin sheet is usually 10 to 1,000 μm, and may be 15 to 500 μm, 60 to 250 μm, or 75 to 220 μm.

### [Laminate]

The laminate according to one embodiment of the invention includes the resin sheet of the present invention as a first layer.

The laminate according to this embodiment preferably further comprise a second layer comprising polypropylene and a petroleum resin. The second layer functions as a base sheet and can further improve the surface hardness of the resin sheet of the present invention.

The laminate according to the present embodiment including the first layer and the second layer preferably has a crystallization speed at 130° C. of 2.5 min⁻¹ or less and an isotactic pentad fraction of 95 mol % or more and 99 mol % or less.

The method of measuring the crystallization speed and the isotactic pentad fraction of the laminate is the same as the method of measuring the crystallization speed and the isotactic pentad fraction of the resin sheet of the present invention, and it is only necessary to change the evaluation target from the resin sheet to the laminate.

As the polypropylene and the petroleum resin included in the second layer of the laminate according to the present embodiment, the same polypropylene and the petroleum resin included in the resin sheet of the present invention can be used.

The preferred contents of the polypropylene and the petroleum resin of the second layer are also the same as the preferred contents of the polypropylene and the petroleum resin of the resin sheet of the present invention.

The second layer may contain a β crystal nucleating agent, but preferably does not contain a β crystal nucleating agent.

When the second layer contains a β crystal nucleating agent, the same β crystal nucleating agent as the β crystal nucleating agent contained in the resin sheet of the present invention can be used. The preferable content of the β crystal nucleating agent of the second layer is also the same as the preferable content when the resin sheet of the present invention contains the β crystal nucleating agent.

80 mass % or more, 90 mass % or more, 95 mass % or more, 98 mass % or more, 99 mass % or more, 99.5 mass % or more, 99.9 mass % or more or 100 mass % of the second layer may be polypropylene and a petroleum resin.

The second layer may be one layer alone or two or more layers of stacked structure.

The thickness of the second layer is preferably between 10 μm and 199 μm, more preferably between 50 μm and 199 μm, and even more preferably between 100 μm and 199 μm.

The second layer can be formed by an extrusion method in the same manner as the resin sheet. The second layer can be formed as a part of the laminate composed of the first layer and the second layer by, for example, coextrusion using material of the first layer and material of the second layer.

The laminate according to the present embodiment preferably further includes a third layer including one or more selected from the group consisting of an urethane resin, an acrylic resin, a polyolefin resin, and a polyester resin.

When the laminate according to the present embodiment includes a third layer, the second layer, the first layer, and the third layer may be included in this order, or the third layer, the second layer, and the first layer may be included in this order. It is preferable that the laminate according to the present embodiment includes the second layer, the first layer, and the third layer in this order.

By providing the third layer (adhesion layer) containing one or more selected from the group consisting of an urethane resin, an acrylic resin, a polyolefin resin, and a polyester resin, even when the laminate is formed into a complex non-planar shape, the third layer can form a layer structure well following the laminate of the first layer and the second layer, and it is possible to prevent the first layer and the second layer from being disadvantageously cracked or peeled.

The urethane resin contained in the third layer is preferably a urethane resin obtained by reacting a diisocyanate, a high molecular weight polyol, and a chain extender. The high molecular weight polyol may be a polyetherpolyol or a polycarbonatepolyol. Commercially available urethane resin includes “HYDRAN WLS-202” (manufactured by DIC Corporation), etc.

Examples of the Acrylic resin include “ACRIT 8UA-366” (manufactured by TAISEI FINE CHEMICAL CO., LTD.) and the like.

Examples of the polyolefin resin include “ARROWBASE DA-1010” (manufactured by UNITIKA LTD.).

Examples of the polyester resin include polyethyleneterephthalate, polybutyleneterephthalate, polyethylenenaphthalate, and the like.

As the third layer, the above-mentioned material may be used alone or in combination of two or more layers.

Among the urethane resin, acrylic resin, polyolefin resin, and polyester resin, the urethane resin is preferable in consideration of adhesion and formability to a fourth layer, a metal layer, and a print layer, which will be described later.

When the third layer includes a polypropylene resin, the polypropylene resin included in the third layer is usually different from the polypropylene included in the first layer and the polypropylene included in the second layer.

80 mass % or more, 90 mass % or more, 95 mass % or more, 98 mass % or more, 99 mass % or more, 99.5 mass % or more, 99.9 mass % or more, or 100 mass % of the third layer may be one or more resins selected from the group consisting of a urethane resin, an acrylic resin, a polyolefin resin, and a polyester resin. For example, the third layer may consist of only a urethane resin.

The glass transition temperature of the third layer is preferably −100° C. or more and 100° C. or less. When the glass transition temperature is −100° C. or more, the strain of the third layer does not exceed the following ability of the metal layer which will be described later, so that a defect due to cracking does not occur even when the third layer is used for a long period of time. When the glass transition temperature is 100° C. or less, the softening temperature is good, so that the elongation at the time of preforming is good, and uneven elongation of the stretched portion and cracking of the metal layer can be suppressed.

The glass-transition temperature of the third layer can be determined by, for example, a differential scanning calorimeter (“DSC-7” manufactured by Perkin Elmer Japan Co., Ltd.) and measuring differential scanning calorimetric curves under the following condition.
Measurement starting temperature: −90° C.
Measurement ending temperature: 220° C.
Temperature rising speed: 10° C./min

The tensile elongation at break of the third layer is, for example, 150% or more and 900% or less, preferably 200% or more and 850% or less, more preferably 300% or more and 750% or less.

If the tensile elongation at break of the third layer is 150% or more, the third layer can follow the elongation of the first layer and the second layer during thermoforming without problem, so that cracking of the third layer and cracking or peeling of the metal layer can be suppressed. When the tensile elongation at break is 900% or less, the water resistance is good.

The tensile elongation at break of the third layer can be evaluated, for example, by coating a resin (e.g., an urethane resin) to be the third layer on a glass substrate with a bar coater, drying the glass substrate at 80° C. for 1 minute, and then separating the glass substrate to prepare a sample having a thickness of 150 μm, and measuring the sample by a method conforming to JIS K7311:1995.

The softening temperature of the third layer is, for example, 50° C. or more and 180° C. or less, preferably 90° C. or more and 170° C. or less, more preferably 100° C. or more and 165° C. or less.

When the softening temperature is 50° C. or more, the third layer is excellent in intensity at room temperature, and cracking or peeling of the metal layer can be suppressed. When the softening temperature is 180° C. or less, the third layer is sufficiently softened at the time of thermoforming, so that cracking of the third layer and cracking or peeling of the metal layer can be suppressed.

The softening temperature of the third layer can be evaluated by, for example, coating a resin (e.g., an urethane resin) to be the third layer on a glass substrate with a bar coater, drying the glass substrate at 80° C. for 1 minute, and then separating the glass substrate to prepare a sample having a thickness of 150 μm, and measuring a flow starting temperature using an elevation type flow tester (“Constant Test Force Extruded Tubular Tube Type Rheometer Flow Tester CFT-500EX” manufactured by Shimadzu Corporation).

The third layer may be one layer alone or two or more layers of stacked structure.

The thickness of the third layer may be 35 nm or more and 3,000 nm or less, 50 nm or more and 2,000 nm or less, or 50 nm or more and 1,000 nm or less.

The third layer can be formed, for example, by coating the above-mentioned resin with a gravure coater, a kiss coater, a bar coater, or the like, and drying at 40 to 100° C. for 10 seconds to 10 minutes.

The laminate according to the present embodiment preferably further includes a fourth layer including one or more selected from the group consisting of a urethane resin, an acrylic resin, a polyolefin resin, and a polyester resin, and the resin included in the fourth layer is different from the resin included in the third layer.

If the laminate according to this embodiment includes the fourth layer, it may include the second layer, the first layer, the third layer, and the fourth layer in this order, or the fourth layer, the third layer, the second layer, and the first layer in this order. It is preferred that the laminate according to this embodiment includes the second layer, the first layer, the third layer, and the fourth layer in this order.

The fourth layer (an undercoat layer) allows the third layer and the metal layer to adhere more closely. By providing the fourth layer, even when stress is applied during thermoforming, it is possible to generate an infinite number of extremely fine cracks in the metal layer, eliminating the occurrence of rainbow phenomenon, or can be reduced.

The urethane resin, acrylic resin, polyolefin resin, and polyester resin of the fourth layer can be the same as those of the third layer, and from the viewpoint of whitening resistance at the time of forming (less occurrence of whitening phenomenon) and adhesion to the metal layer, it is preferable to include an acrylic resin.

As the acrylic resin, for example, “DA-105” manufactured by Arakawa Chemical Co., Ltd. can be used.

The fourth layer may include a curing agent. Examples of the curing agent include an aziridine-based compound, a blocked isocyanate compound, an epoxy-based compound, an oxazoline compound, a carbodiimide compound, and the like, and for example, “CL102H” manufactured by Arakawa Chemical Co., Ltd. can be used.

When the fourth layer includes a curing agent, the content ratio of the base agent (one or more selected from the group consisting of a urethane resin, an acrylic resin, a polyolefin resin, and a polyester resin) and the curing agent in the fourth layer is, for example, 35:4 to 35:40, preferably 35:4 to 35:32, more preferably 35:12 to 35:32 in terms of the mass ratio of the solid content. It may be 35:12 to 35:20.

When the blending amount of the curing agent is 4 or more with respect to the main agent 35, the curing reaction proceeds without any problem, and the whitening resistance can be maintained. If it is 40 or less, the extensibility of the fourth layer is good, and cracking at the time of forming can be suppressed.

For example, 80 mass % or more, 90 mass % or more, 95 mass % or more, 98 mass % or more, 99 mass % or more, 99.5 mass % or more, 99.9 mass % or more, or 100 mass % of the fourth layer may be the above resin component (one or more selected from the group consisting of an urethane resin, an acrylic resin, a polyolefin resin, and a polyester resin) and the curing agent optionally included.

The fourth layer may be one layer alone or two or more layers of stacked structure.

The thickness of the fourth layer may be between 0.05 μm and 50 μm, between 0.1 μm and 10 μm, or between 0.5 μm and 5 μm.

The fourth layer can be formed, for example, by coating the above-mentioned material with a gravure coater, a kiss coater, a bar coater, or the like, drying at 50 to 100° C. for 10 seconds to 10 minutes, and aging at 40 to 100° C. for 10 to 200 hours.

The laminate according to this embodiment preferably includes a metal layer containing a metal or an oxide of the metal.

The metal layer is preferably laminated on top of the third layer (on the opposite side of the third layer from the first layer) or on top of the fourth layer (on the opposite side of the fourth layer from the third layer).

The metal forming the metal layer is not particularly limited as long as it can impart a metal-like design to the laminate, and includes, for example, tin, indium, chromium, aluminum, nickel, copper, silver, gold, platinum, and zinc, and an alloy containing at least one of them may be used.

Among the above metals forming the metal layer, indium, aluminum, and chromium are preferable because they are particularly excellent in extensibility and color tone. When the metal layer is excellent in extensibility, cracking is less likely to occur when the laminate is three-dimensionally formed.

The method of forming the metal layer is not particularly limited, but from the viewpoint of providing a metal-like design having a high texture and a high-grade feeling to the laminate, for example, a deposition method such as a vacuum deposition method, a sputtering method, an ion plating method, or the like using the above metal can be used. In particular, the vacuum deposition method is low in cost and can reduce damage to the object to be deposited. The conditions of the vacuum evaporation method may be appropriately set depending on the melting temperature or the evaporation temperature of the metal used.

In addition to the above method, a method of coating a paste containing the above metal or metal oxide, a plating method using the above metal, or the like can be used.

The thickness of the metal layer may be 5 nm or more 80 nm or less. When the thickness is 5 nm or more, a desired metal gloss is obtained without any problem, and when the thickness is 80 nm or less, cracking is hardly generated.

The laminate according to this embodiment preferably includes a print layer.

The print layer is preferably provided on one side (the side of the metal layer facing the third layer or the side of the metal layer facing away from the third layer) of the metal layer.

The print layer may be provided on a part of or all of the surface of the metal layer. The shape of the print layer is not particularly limited, and various shapes such as a solid shape, a carbon tone, and a wood grain tone can be given.

As a printing method, a general printing method such as a screen printing method, an offset printing method, a gravure printing method, a roll coating method and a spray coating method can be used. In particular, in the screen printing method, since the thickness of the ink can be increased, ink cracking does not easily occur when the it is formed into a complicated shape.

For example, in the case of screen printing, the ink having excellent elongation at the time of forming is preferred, and “FM3107 high-concentration white” or “SIM3207 high-concentration white” manufactured by Jujo Chemical Co., Ltd. can be exemplified, but is not limited.

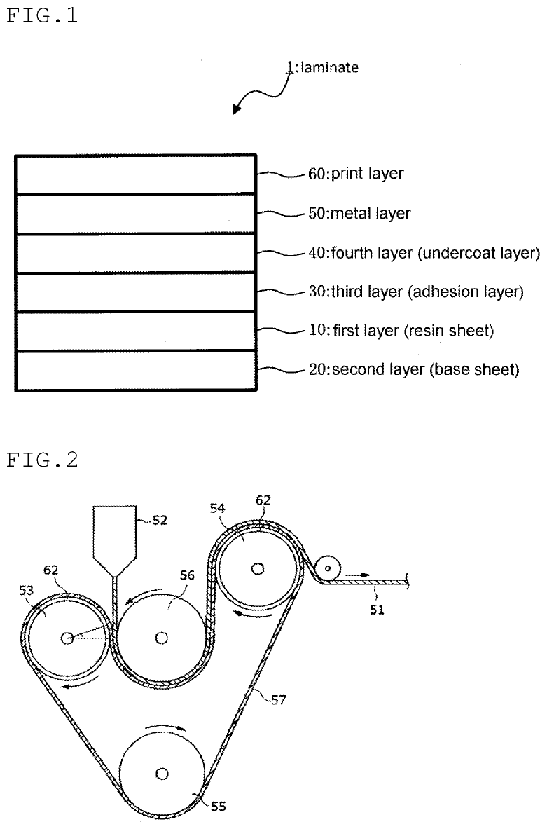

A schematic cross-sectional view showing an embodiment of a laminate according to this embodiment is shown in FIG. 1. Note that FIG. 1 is merely for explaining the layer structure of the laminate according to the present embodiment, and the aspect ratio and the film thickness ratio are not necessarily accurate.

The laminate 1 of FIG. 1 is a laminate in which a second layer (base sheet) 20, a first layer (resin sheet) 10, a third layer (adhesion layer) 30, a fourth layer (undercoat layer) 40, a metal layer 50, and a print layer 60 are laminated in this order.

It is enough for the laminate according to this embodiment to include the first layer 10 which is the resin sheet of the present invention, and one or more selected from the second layer 20, the third layer 30, the fourth layer 40, the metal layer 50, and the print layer 60 may be arbitrarily provided. Also, the stacking order is not limited to the stacking order of the laminate 1 in FIG. 1. For example, the laminate according to the present embodiment may be a laminate in which the first layer (resin sheet) 10, the second layer (base sheet) 20, the third layer (adhesion layer) 30, the fourth layer (undercoat layer) 40, the metal layer 50, and the print layer 60 are laminated in this order.

In the laminate according to the present embodiment, various coating such as an ink, a hard coat, an anti-reflection coat, or a heat shield coat can be provided on the third layer (on the opposite side of the first layer).

One more third layer (adhesion layer) may be provided on the surface of the second layer opposite to the first layer (second adhesion layer). By doing so, it is possible to impart functionality such as surface treatment and hard coating to the second layer serving as the surface of the formed body.

### [Method for Producing Laminate]

The method of producing the laminate according to one embodiment of the invention is not particularly limited, and for example, a resin sheet (first layer), or a laminate of a resin sheet (first layer) and a base sheet (second layer) can be formed by the method described in the examples, and another layer can be optionally provided by the method described above to form a laminate.

### [Formed Body]

The laminate of the present invention can be used to produce a formed body.

In the formed body according to one embodiment of the invention, it is preferable that the polypropylene of the first layer has an isotactic pentad fraction of 95 mol % or more and 98 mol % or less. The crystallization speed of the polypropylene at 130° C. is preferably 2.5 min⁻¹ or less, and more preferably 2.0 min⁻¹ or less.

By using a phase microscope or the like even after the formed body is formed, it is possible to specify a portion of the laminated body corresponding to the first layer.

When indium or indium dioxide is used in the metal layer, the glossiness of the formed body according to one embodiment of the invention can be, for example, 250% or more, 300% or more, 400% or more, 500% or more, or 600% or more. If the glossiness of the formed body is 250% or more, sufficient metallic glossiness can be developed and a design having an excellent metallic tone can be given to the formed body.

When aluminum or aluminum oxide is used in the metal layer, the glossiness of the formed body according to one embodiment of the invention can be, for example, 460% or more, 480% or more, 500% or more or 520% or more. If the glossiness of the formed body is 460% or more, the metallic glossiness is sufficiently developed, and a design having an excellent metallic tone can be given to the formed body.

When chromium or chromium oxide is used in the metal layer, the glossiness of the formed body according to one embodiment of the invention can be, for example, 150% or more, 180% or more, 200% or more or 220% or more. If the glossiness of the formed body is 150% or more, the metallic glossiness can be sufficiently developed and a design having an excellent metallic tone can be given to the formed body.

The glossiness of the formed body can be evaluated by the following method.

For the formed body, according to the measuring method of 60° specular gloss of JIS Z8741:1997, an automatic colorimetric color difference meter (AUD-CH-2 type-45,60, manufactured by Suga Tester Co., Ltd.) is used, light is irradiated to the surface of the first layer (resin sheet) opposite to the surface in contact with the third layer (adhesion layer) at an incident angle of 60° , and the reflected light is received at 60° at the same time, the reflected light flux ψs is measured, and the glossiness can be calculated by the ratio of the refractive index 1.567 to the reflected light flux ψ0s from the glass surface by the following equation (1).

Degree of brilliancy (Gs)=(ψs/ψ0s)*100 (1)

### [Method for Producing Formed Body]

Methods for producing formed body according to one embodiment of the invention include in-mold molding, insert molding, coating molding, and the like.

The in-mold molding is a method of obtaining a formed body by placing a laminate in a mold, and then molding the laminate into a desired shape with the pressure of the resin for molding supplied into the mold.

The in-mold molding is preferably carried out by attaching a laminate to a die, and supplying a resin for molding thereto to integrate the laminate with the resin.

The insert molding is a method of obtaining a formed body by preliminarily preparing a shaped body to be placed in a mold, and filling a resin for molding into the shaped body to obtain the formed body. By this method, more complex shapes can be formed.

As insert molding, the laminate can be shaped to match the mold, the shaped laminate can be fitted on the mold, and the resin for molding can be supplied and integrated.

The shaping (pre-shaping) performed so as to conform to the mold can be performed by a vacuum molding, an air pressure molding, a vacuum pneumatic molding, a press molding, a plug assist molding, or the like.

As the resin for molding, a formable thermoplastic resin can be used. Specifically, polypropylene, polyethylene, polycarbonate, an acetylene-styrene-butadiene copolymer, an acryl polymer, and the like can be, but not limited thereto. A fiber or an inorganic filler such as talc may be added thereto.

Supply of the resin for molding is preferably performed by injection, and the pressure is preferably 5 MPa or more and 120 MPa or less. A mold temperature is preferably 20° C. or higher and 90° C. or lower.

The coating molding method includes arranging a core material in a chamber box, arranging the laminate above the core material, depressurizing the inside of the chamber box, heating and softening the laminate, and pressing the heated and softened laminate against the core material to cover the core material.

After heating and softening, the laminate may be brought into contact with the upper surface of the core material. Pressing can be performed by pressurizing the opposite side of the core material of the laminate in the chamber box, while depressurizing the side in contact with the core material of the laminate.

The core material may be in a convex form or a concave form, and specific examples thereof include a resin, metal and ceramic having a three-dimensional curve. Resins include the same resin used for forming described above.

As the above method, it is possible to use a chamber box of two upper and lower molding chambers which are separable from each other.

First, the core material is placed and set on a table in the lower molding chamber. The laminate of the present invention which is an object to be molded is fixed by clamping the lower molding chamber upper surface. On the occasion, pressure inside the upper and lower molding chambers is atmospheric pressure.

Then, the upper molding chamber is descended to bond the upper and lower molding chambers into a closed state inside the chamber box. Both insides of the upper and lower molding chambers are made to a vacuum suction state from an atmospheric pressure state by a vacuum tank.

After the insides of the upper and lower molding chambers are formed into the vacuum suction state, the laminate is heated by turning on a heater. Then, the table in the lower molding chamber is ascended with keeping the insides of the upper and lower molding chambers in the vacuum state.

Then, vacuum inside the upper molding chamber is opened to introduce the atmospheric pressure thereinto, whereby the laminate or the present invention being the object to be molded is pressed onto the core material and is overlaid (molded). In addition, compressed air can be supplied into the upper molding chamber, whereby the laminate being the object to be molded can also be adhered onto the core material with larger force.

After the overlay is completed, the heater is turned off, the vacuum in the lower molding chamber is also opened to return to the atmospheric pressure state, to raise the upper molding chamber, and a decorative printed product coated with the laminate as a skin material can be taken out.

### [Use of Formed Body]

The laminate and the formed body of the present invention can be used for the outer parts of the saddle-ride type vehicles or the outer parts of the four-wheel vehicles.

Further, the laminate and the formed body of the present invention can be used for an interior or an exterior material of a vehicle, a housing of a home appliance, a decorative steel plate, a decorative plate, a housing facility, a housing of an information communication device, and the like.

### EXAMPLES

Hereafter, the invention will be described with reference to Examples and Comparative Examples. However, the invention is not limited to these Examples.

Components used in Examples and Comparative Example are shown below.
Polypropylene: trade name “Prime Polypro™ F-133A” (manufactured by Prime Polymer Co., Ltd.; MFR: 3 g/10 min; homopolypropylene)
Petroleum Resin: trade name “I-MARV P-140” (aromatic hydrogenated petroleum resin; manufactured by Idemitsu Kosan Co., Ltd.; softening point: 140° C.; average molecular weight: 900)
β crystal nucleating agent: trade name “N Jester NU-100” (N,N′-dicyclohexyl-2,6-naphthalenedicarboxamide; manufactured by Shin Nippon Rika Co., Ltd.)
Dispersant: trade name “ISU-200” (manufactured by Takemoto Oil & Fat Co., Ltd.)

### [Production and Evaluation of Resin Sheet]

### Example 1

A resin sheet was produced using the device shown in FIG. 2.

Operation of the apparatus will be described. A melted resin of polypropylene and a petroleum resin having a composition shown in Table 1 extruded from T-die 52 of an extruder is interposed between a metal endless belt 57 and a fourth cooling roll 56 on a first cooling roll 53. In this state, the melted resin is pressure-welded with the first cooling roll 53 and the fourth cooling roll 56 and simultaneously rapidly cooled.

The resin sheet is subsequently interposed between the metal endless belt 57 and the fourth cooling roll 56 in a circular arc part corresponding to a substantially lower semicircle of the fourth cooling roll 56, and pressure-welded in a planar form. The resin sheet is pressure-welded in the planar form and cooled with the fourth cooling roll 56, and the resin sheet adhered to the metal endless belt 57 is moved onto the second cooling roll 54 together with turning of the metal endless belt 57. In a manner similar to the above description, the resin sheet is pressure-welded in a planar form with the metal endless belt 57 in a circular arc part corresponding to a substantially upper semicircle of the second cooling roll 54, and cooled again, and the polypropylene sheet 51 cooled on the second cooling roll 54 is then peeled from the metal endless belt 57. An elastic material 62 made of nitrile-butadiene rubber (NBR) is coated on surfaces of the first cooling roll 53 and the second cooling roll 54. the third cooling roll 55 has a function of supporting the metal endless belt 57 at its lower part and rotating.

The conditions for producing the resin sheet are as follows.
Diameter of the extruder: 75 mm
Width of the T-die 52: 900 mm
Thickness: 200 μm
Collection rate of the resin sheet 51: 4.5 m/min
Surface temperatures of the fourth cooling roll 56 and the metal endless belt 57: 20° C.
Cooling speed: 8,100° C./min p The following evaluations were performed on the obtained resin sheet. Table 1 shows the results.

### (Crystallization Speed (Speed))

A crystallization speed was measured on the resin sheet using a differential scanning calorimeter (DSC) (“Diamond DSC,” manufactured by PerkinElmer, Inc.). Specifically, the resin sheet was heated from 50° C. to 230° C. at 10° C./min, held at 230° C. for 5 minutes, and cooled from 230° C. to 130° C. at 80° C./min, and then crystallized by being held at 130° C. Measurement was started on a heat quantity change from a time point at which the polypropylene reached 130° C. to obtain a DSC curve. The crystallization speed was determined from the DSC curve obtained according to procedures (i) to (iv) described below.
(i) A line obtained by approximating, by a straight line, a heat quantity change from a time point of 10 times the time from starting of measurement to a maximum peak top to a time point of 20 times the time was applied as a baseline.
(ii) An intersection point between a tangent having an inclination at an inflection point of a peak and the baseline was determined to determine a crystallization starting time and a crystallization ending time.
(iii) A time from the crystallization starting time obtained to a peak top was measured as a crystallization time.
(iv) The crystallization speed was determined from a reciprocal of the crystallization time obtained.

### (Isotactic Pentad Fraction)

A ¹³C-NMR spectrum was evaluated on the resin sheet to measure an isotactic pentad fraction. Specifically, according to attribution of peaks proposed in “Macromolecules, 8, 687 (1975)” by A. Zambelli et al., the measurement was performed using an apparatus, conditions and a calculation formula as described below. The isotactic pentad fraction was 98 mol %.

### (Apparatus and Conditions)

Apparatus: ¹³C-NMR spectrometer (“JNM-EX400” model, manufactured by JEOL Ltd.)
Method: complete proton decoupling method (concentration: 220 mg/mL)
Solvent: mixed solvent of 1,2,4-trichlorobenzene and hexadeuterobenzene (90:10 (volume ratio))
Temperature: 130° C.
Pulse width: 45°
Pulse repetition time: 4 seconds
Accumulation: 10,000 times
   (Calculation formula)

Isotactic pentad fraction [mmmm]=m/S×100

(where, S represents signal intensity of side chain methyl carbon atoms in all propylene units, and m represents a meso pentad chain (21.7 to 22.5 ppm).)

The obtained resin sheet was also evaluated as follows. Table 1 shows the results.

### (Thickness)

The thickness of the resin sheet was measured by observing the cross section of the resin sheet using a phase contrast microscope (“ECLIPSE80i” manufactured by Nikon Co., Ltd.).

### (Pencil Hardness)

The pencil hardness of the resin sheet was measured in accordance with JIS-K5600-5-4 scratch hardness (pencil method).

(Martens hardness)

Martens hardness of the resin sheet was measured using a microhardness meter (“FischerScope HM2000Xyp” manufactured by Fisher Instruments Co., Ltd.). A measuring conditions are shown below.
Indenter: Vickers quadrangular pyramid indenter
Load: 0 to 96 mN
Test time: 30 seconds
Test temperature: Room temperature (24° C. controlled environment)

### (Smectic Phase Crystal)

The crystal structure of polypropylene in the resin sheet was confirmed by measuring the scatter patterns of wide-angle X-rays using an X-ray generator (“model ultra X 18HB” manufactured by Rigaku Co., Ltd.) under the following measuring condition and identified. As a result, a peak of a smectic phase crystal type was observed even when the peaks were separated, so that it was confirmed that the smectic phase crystal was present in the obtained resin sheet.

### (Measurement Conditions)

Source output: 50 kV
X-rays: Monochromatic light of 300 mACuKα rays (wavelength: 1.54 A)

### Examples 2-6 and Comparative Examples 1-2

A resin sheet was produced and evaluated in the same manner as in Example 1 except that the melted resin having the composition shown in Table 1 was used as the melted resin used for the production of the resin sheet. Table 1 shows the results.

TABLE 1

| | | Example 1 | Example 2 | Example 3 | Example 4 | Example 5 | Example 6 | Com. Ex. 1 | Com. Ex. 2 |
|---|---|---|---|---|---|---|---|---|---|
| Composition | Polypropylene | 90 | 89 | 88.8 | 99.5 | 99 | 95 | 100 | 100 |
| [mass %] | β crystal nuclear agent | | 1 | 1 | 0.5 | 1 | | | |
| | Dispersing agent | | | 0.2 | | | | | |
| | Petroleum resin | 10 | 10 | 10 | | | 5 | | |
| Characteristics | Isotactic pentad fraction | 98 | 98 | 98 | 98 | 98 | 98 | 98 | 92 |
| of sheet | [mol %] | | | | | | | | |
| | Thickness [μm] | 200 | 200 | 200 | 200 | 200 | 200 | 200 | 200 |
| | Crystallization speed | 0.28 | 0.45 | 0.36 | 0.69 | 0.74 | 0.37 | 0.46 | 0.33 |
| | [min⁻¹] | | | | | | | | |
| | Pencil hardness | H | H | H | F | F | F | HB | B |
| | Martens hardness | 88 | 91.7 | 83.3 | 63.7 | 64.1 | 68.2 | 56 | 44.7 |
| | [MPa] | | | | | | | | |

### [Production and Evaluation of Laminate]

### Examples 7-10

The same operation was performed using the same apparatus as that for producing the resin sheet of Example 1, and a laminate composed of the resin sheet and the base sheet was produced and evaluated, except that the melted resin for producing the resin sheet having the composition shown in Table 2 and the melted resin for producing the base sheet having the composition shown in Table 2 were coextruded from the extruder using the extruder described below so as to have the layer ratio (resin sheet/base sheet) shown in Table 2. The results are shown in Table 2.
Diameter of the extruder for the first layer (resin sheet): 50 mm
Diameter of the extruder for the second layer (base sheet): 75 mm

The method for evaluating the isotactic pentad fraction, crystallization speed, pencil hardness, and martens hardness of the laminate of Table 2 is the same as that of Example 1 except that the evaluation target is changed from the resin sheet to the laminate.

The results of evaluating the isotactic pentad fraction and crystallization speed of the resin sheet in Table 2 are the results of separately manufacturing and evaluating the resin sheet having the composition shown in Table 2 in the same manner as in Example 1.

TABLE 2

| | | | Example 7 | Example 8 | Example 9 | Example 10 |
|---|---|---|---|---|---|---|
| Composition | Resin sheet | Polypropylene | 88.9 | 88.9 | 88.9 | 88.9 |
| [mass %] | | β crystal nuclear agent | 1 | 1 | 1 | 1 |
| | | Dispersing agent | 0.1 | 0.1 | 0.1 | 0.1 |
| | | Petroleum resin | 10 | 10 | 10 | 10 |
| | Base sheet | Polypropylene | 90 | 90 | 90 | 90 |
| | | Petroleum resin | 10 | 10 | 10 | 10 |

| | | | | | |
|---|---|---|---|---|---|
| Characteristics of | Isotactic pentad fraction [mol %] | 98 | 98 | 98 | 98 |
| sheet | Crystallization speed [min⁻¹] | 0.38 | 0.38 | 0.38 | 0.38 |
| Characteristics of | Isotactic pentad fraction [mol %] | 98 | 98 | 98 | 98 |
| laminate | Thickness [μm] | 200 | 200 | 200 | 200 |
| | Layer ratio | 35/65 | 45/55 | 51/49 | 16/84 |
| | (Resin sheet/Base Sheet) | | | | |
| | Crystallization speed [min⁻¹] | 1.25 | 1.11 | 1.00 | 0.967 |
| | Pencil hardness | H | H | F | F |
| | Martens hardness [MPa] | 89.4 | 82.1 | 78.9 | 76.5 |

Several embodiments and/or Examples of the present invention have been described in detail above, but those skilled in the art will readily make a great number of modifications to the exemplary embodiments and/or Examples without substantially departing from new teachings and advantageous effects of the invention. Accordingly, all such modifications are included within the scope of the invention.

The entire contents of the description of the Japanese application serving as a basis of claiming the priority concerning the present application to the Paris Convention are incorporated by reference herein.

1. A resin sheet comprising polypropylene and one or more selected from the group consisting of a β crystal nucleating agent and a petroleum resin,
wherein the resin sheet has a crystallization speed at 130° C. of 2.5 min⁻¹ or less and an isotactic pentad fraction of 95 mol % or more and 99 mol % or less.

2. The resin sheet according to claim 1, wherein the polypropylene is a propylene homopolymer.

3. The resin sheet according to claim 1, wherein the polypropylene comprises a smectic phase crystal.

4. The resin sheet according to claim 1, wherein the polypropylene has an exothermic peak of 1.0 J/g or more on a low temperature side of a maximum endothermic peak on a differential scanning calorimetry curve.

5. The resin sheet according to claim 1, wherein the β crystal nucleating agent is an amide compound.

6. The resin sheet according to claim 1, wherein the β crystal nucleating agent is comprised in an amount of 10,000 mass ppm or more and 100,000 mass ppm or less.

7. The resin sheet according to claim 1, wherein the petroleum resin is a hydrogenated aromatic petroleum resin.

8. The resin sheet according to claim 1, wherein the petroleum resin is comprised in an amount of 10 mass % or more and 30 mass % or less.

9. The resin sheet according to claim 1, which further comprises a dispersant.

10. The resin sheet according to claim 9, wherein the dispersant is one or more selected from the group consisting of alkyldiethanolamine, polyoxyethylenealkylamide, monoglycerin fatty acid ester, and diglycerin fatty acid ester.

11. The resin sheet according to claim wherein the dispersant is comprised in an amount of 10 mass ppm or more and 10,000 mass ppm or less.

12. A laminate comprising the resin sheet according to claim 1 as a first layer.

13. The laminate according to claim 12 which comprises a second layer comprising polypropylene and a petroleum resin.

14. The laminate according to claim 13, wherein the laminate has a crystallization speed at 130° C. of 2.5 min⁻¹ or less and an isotactic pentad fraction of 95 mol % or more and 99 mol % or less.

15. The laminate according to claim 13, wherein the polypropylene in the second layer is a propylene homopolymer.

16. The laminate according to claim 13, wherein the polypropylene in the second layer comprises a smectic phase crystal.

17. The laminate according to claim 13, wherein the polypropylene of the second layer has an exothermic peak of 1.0 J/g or more on a low temperature side of a maximum endothermic peak on a differential scanning calorimetry curve.

18. The laminate according to claim 13, wherein the petroleum resin in the second layer is a hydrogenated aromatic petroleum resin.

19. The laminate according to claim 13, wherein the second layer comprises the petroleum resin in an amount of 10 mass % or more and 30 mass % or less.

20. The laminate according to claim 13, which further comprises a third layer comprising one or more selected from the group consisting of an urethane resin, an acrylic resin, a polyolefin resin, and a polyester resin,
wherein the laminate comprises the second layer, the first layer and the third layer in this order, or the laminate comprises the third layer, the second layer and the first layer in this order.

21. The laminate according to claim 13, which further comprises a third layer comprising one or more selected from the group consisting of an urethane resin, an acrylic resin, a polyolefin resin, and a polyester resin, and a fourth layer comprising a resin which is one or more selected from the group consisting of an urethane resin, an acrylic resin, a polyolefin resin and a polyester resin, and is different from the resin comprised in the third layer,
wherein the laminate comprises the second layer, the first layer, the third layer, and the fourth layer in this order, or the laminate comprises the fourth layer, the third layer, the second layer, and the first layer in this order.

22. The laminate according to claim 20, wherein the laminate comprises a metal layer comprising a metal or an oxide of the metal on a surface of the third layer which is an opposite side to the first layer.

23. The laminate according to claim 21, wherein the laminate comprises a metal layer comprising a metal or an oxide of the metal on a surface of the fourth layer which is an opposite side to the third layer.

24. The laminate according to claim 22, wherein the metal element comprised in the metal layer is one or more selected from the group consisting of tin, indium, chromium, aluminum, nickel, copper, silver, gold, platinum, and zinc.

25. The laminate according to claim 22, wherein the metal element comprised in the metal layer is one or more selected from the group consisting of indium, aluminum, and chromium.

26. The laminate according to claim 22, which comprises a print layer on a part or entire surface of the metal layer opposite to the third layer.

27. A formed body of the laminate according to claim 12.

28. A method for producing a formed body by forming the laminate according to claim 12 to obtain a formed body.

29. The method for producing a formed body according to claim 28, wherein the forming is performed by placing the laminate on a mold and supplying a resin for molding to integrate the laminate and the resin for molding.

30. The method for producing a formed body according to claim 28, wherein the forming is performed by shaping the laminate so as to conform to a mold, placing the shaped laminate to the mold, and supplying a resin for molding to integrate the shaped laminate and the resin for molding.

31. The method for producing a formed body according to claim 28, wherein the forming is performed by arranging a core material in a chamber box, arranging the laminate above the core material, depressurizing the inside of the chamber box, heating and softening the laminate, and pressing the heated and softened laminate against the core material to cover the core material.
